(19) United States
(12) Patent Application Publication
(10) Pub. No.: US 2018/0043796 A1
(43) Pub. Date: Feb. 15, 2018

(54) Recreational vehicle accessory patent

(71) Applicant: Spencer Dean Rogers, Orange, CA (US)

(72) Inventor: Spencer Dean Rogers, Orange, CA (US)

(21) Appl. No.: 13/424,759

(22) Filed: Mar. 20, 2012

(51) Int. Cl. B60N 2/005; B60R 9/12; A47C 7/74; B60R 3/00; A47C 4/52; B60R 9/10; B60R 9/06

(52) U.S. Cl. CPC B60N 2/005; B60R 9/10; B60R 9/12; B60R 9/06; B60R 3/005; A47C 4/52; A47C 7/748; A47C 7/744

(57) ABSTRACT

In one embodiment, a foldable chair is provided that allows easy access to a truck bed, the foldable chair including a ladder and a chair attached to the tailgate of the truck bed, can also be used as a bicycle rack the tail gate is closed.

This application claims the benefit of U.S. Provisional Application No. 61/627,642 filed Oct. 17, 2011 and non-provisional Ser. No. 13/424,759 filed Mar. 20, 2012.

As set forth herein in one embodiment referred to as the Original Tail Gator (OTG), a method and apparatus is provided that can be used as a chair, a recliner, a bicycle rack, and/or a ladder for access to a pick-up truck bed using the OTG.

Some embodiments of the OTG provide a means of access and comfort by combining a folding ladder and a folding chair/recliner which can be used on the tailgate of a pick-up truck (see FIG. 2) or for use on the ground (see FIG. 7). An apparatus consisting of but not limited to one or more of the following accessories, which may be added to the OTG:
Awning (100)
Lighting, speakers, LED Display, Bug Diversion System (mosquito netting, fan, etc.).
Heater, massager, body cooler, lumbar support, armrest, headrest.

Currently, nothing is offered for sale on the market which folds up for easy storage that combines the comfort of a chair/recliner, a bicycle rack, and a ladder. There exist several ways of operating the OTG including but not limited to the removal of certain parts and various folding directions, the following descriptions and drawings show some but not all various combinations and of parts and folding directions. The invention is not limited by the examples given in the drawings and description. For example see FIG. 9.

Some embodiments of the OTG focus on the three goals, comfort, a bicycle rack, and access to a truck bed using the OTG. It takes a few minutes to unfold and attach the unit to the tailgate (see FIG. 3) or placed on the ground using 140 & 230 as legs (see FIG. 7). Once the OTG is installed on the tailgate the tailgate can be opened or closed with the OTG still attached, for easy use.

Other features and advantages of some embodiments of the present invention will become apparent from the following detailed description. It should be understood, however, that the detailed description and the specific examples, while indicating the preferred embodiments of the present invention are given by way of illustration only. Various changes and modifications within the spirit and scope of the present invention will become apparent to those skilled in the art from the following brief and detailed descriptions.

### BRIEF DESCRIPTIONS OF DRAWINGS

(The line drawings represent the folding frame work of the OTG made of the listed materials such as steel).

FIG. 1 is the OTG in the Ladder 140 & Handle 110 positions

FIG. 2 is the OTG in the chair/recliner positions on the tailgate of a truck.

FIG. 3 is an example of a possible attachment system 200.

FIG. 4 is a folding side step 150 located at the bottom of the ladder 140.

FIG. 5 is one of the many possible hinge types.

FIG. 6 another hinge type that allows the tail gate to be closed while the OTG is still attached.

FIG. 7 shows the OTG sitting on the ground, using the 140 & 230 in the down position.

FIG. 8 shows how 210 is tethered or leashed 240 to the frame at the back of the seat 120.

FIG. 9 shows tie down ratchet system 250 with a lever 260 and attachment hooks 190.

FIG. 10 Location of the Bicycle Rack Attachment System 140a.

FIG. 11 Bicycle Rack with 2 bicycle rack hooking system 140b and attachment system 140c.

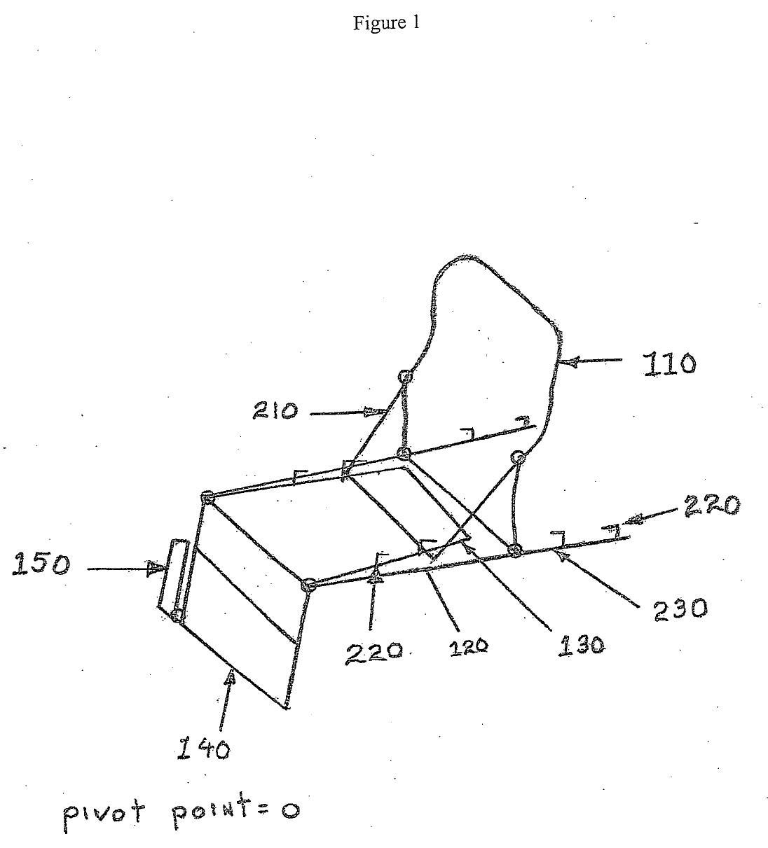

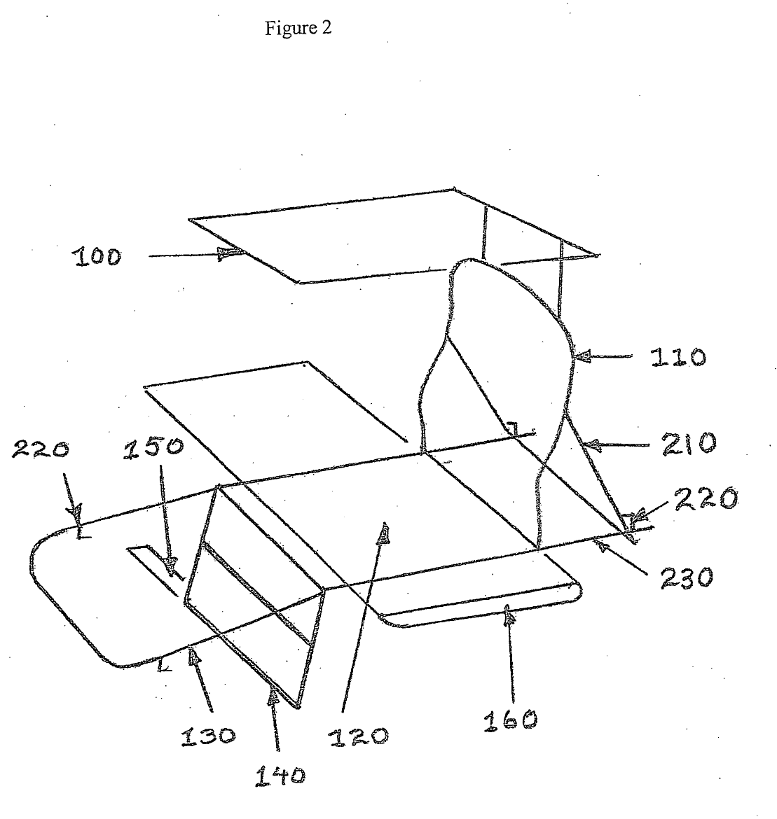

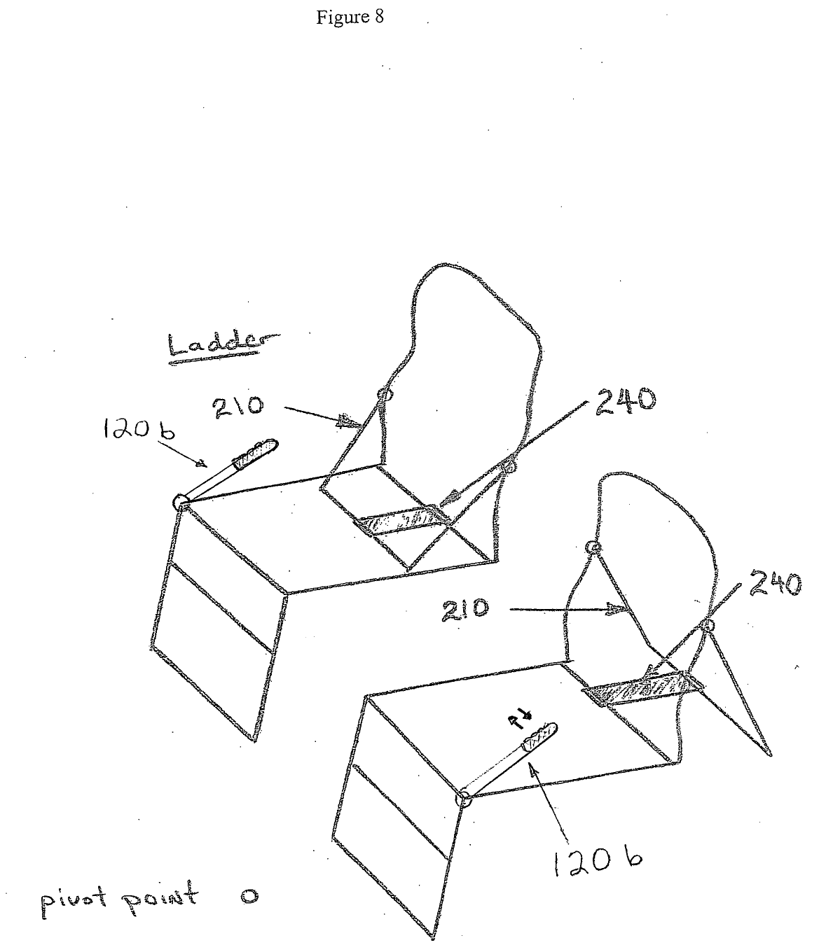

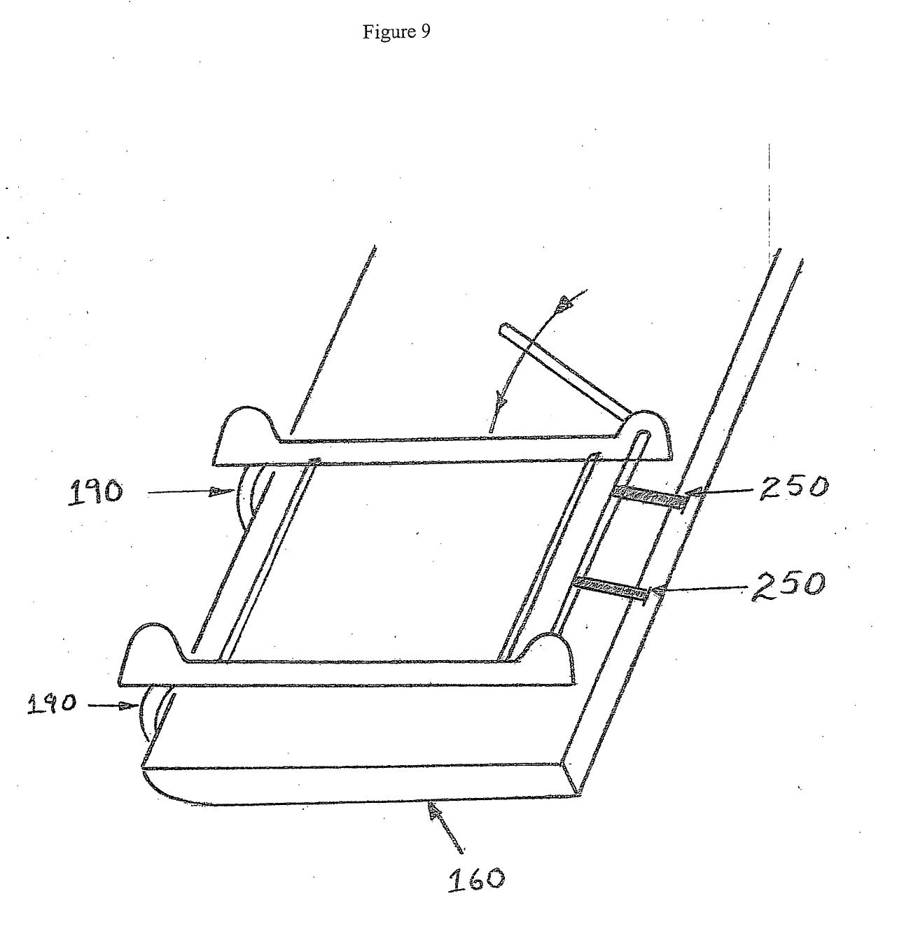

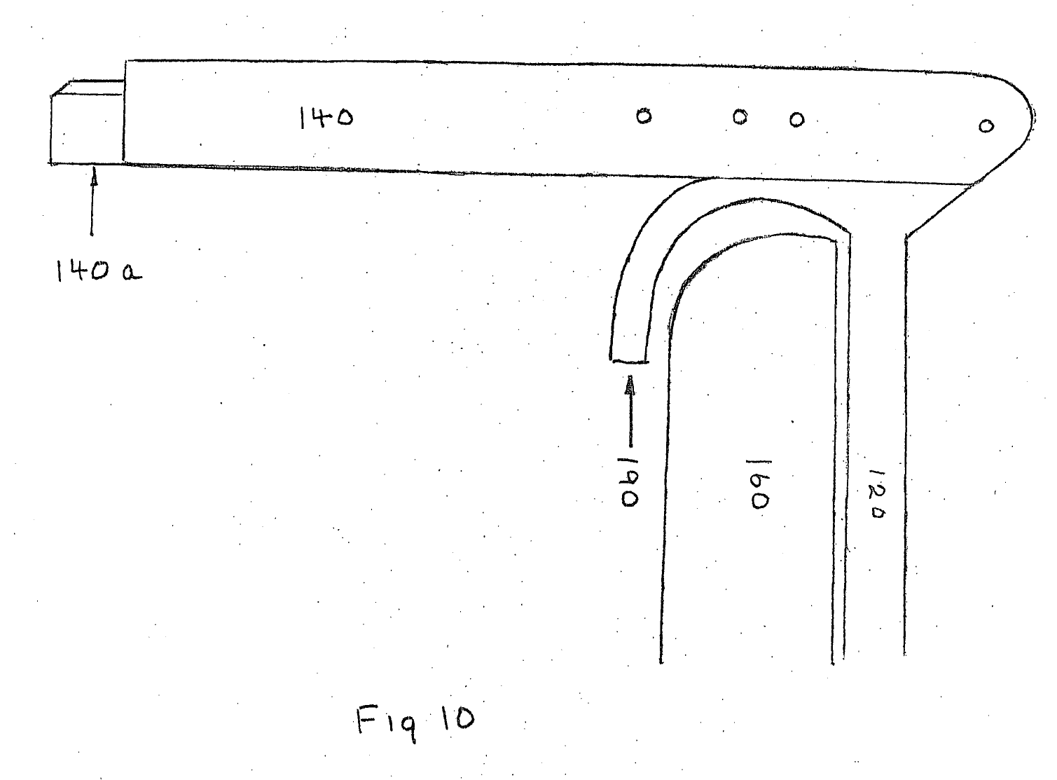

FIG. 1 shows the OTG in the ladder position showing the leg rest 130 folded up & the backrest 110 folded forward towards the ladder so the backrest 110 becomes a handle for the ladder (Dual Purpose). The backrest support 210 for the backrest/handle 110 uses either the angled stops 220 or an adjustable nylon leash 240 (see FIG. 8).

FIG. 2 shows the OTG on a truck's tailgate 160 in the chair/recliner position 150 with the side step in the down position & the awning 100 is attached.

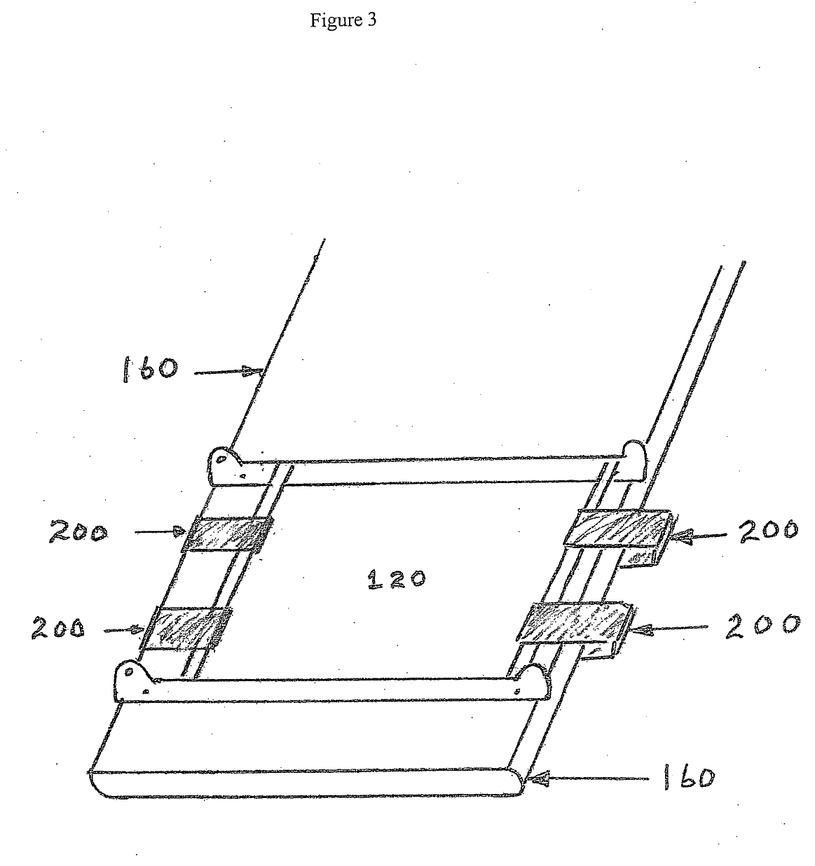

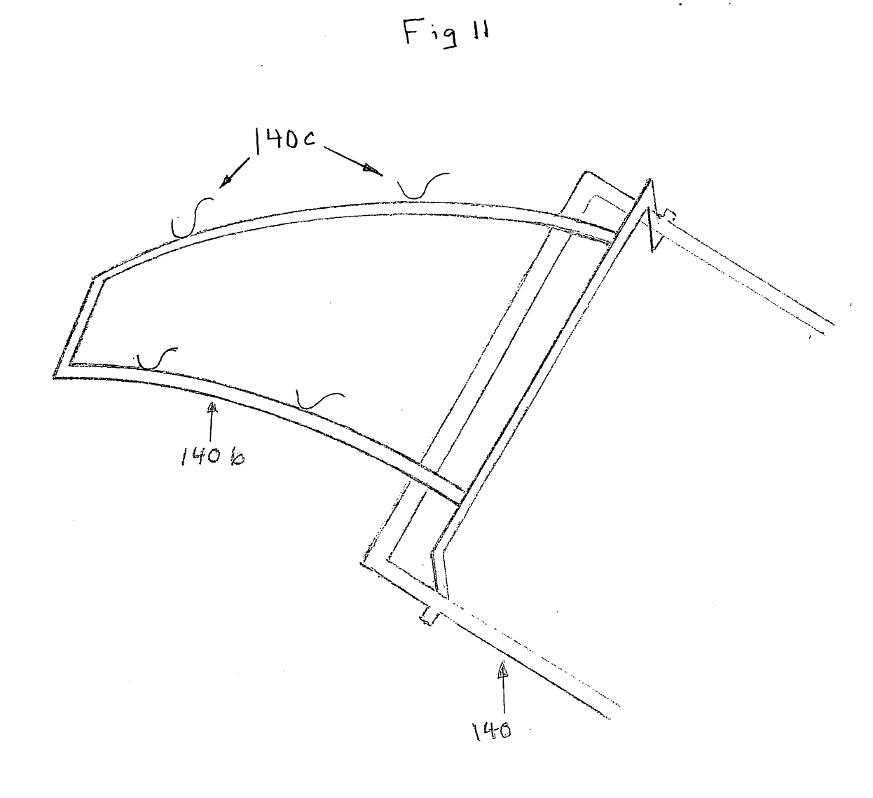

FIG. 3 shows the seat 120, safety straps 200, and tailgate 160. In one embodiment the OTG is installed easily, simply unfold the ladder section, use locking pins, and place the OTG on the tailgate, securing the apparatus with its safety straps with Velcro 200 or with nylon straps and metal hooks (see FIG. 9). The OTG is ready for use as a ladder or chair/recliner.

In another aspect, the system can also include other features and options such as an apparatus for accessing the vehicles electric source, for use with the various electrical accessories mentioned in section 0003.

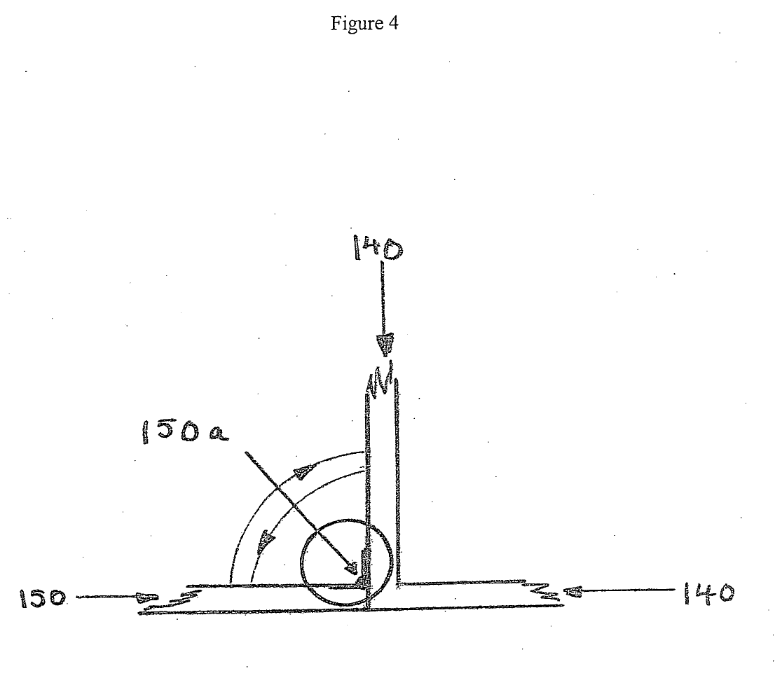

FIG. 4 shows the hinge 150a between the ladder 140 & the side step 150.

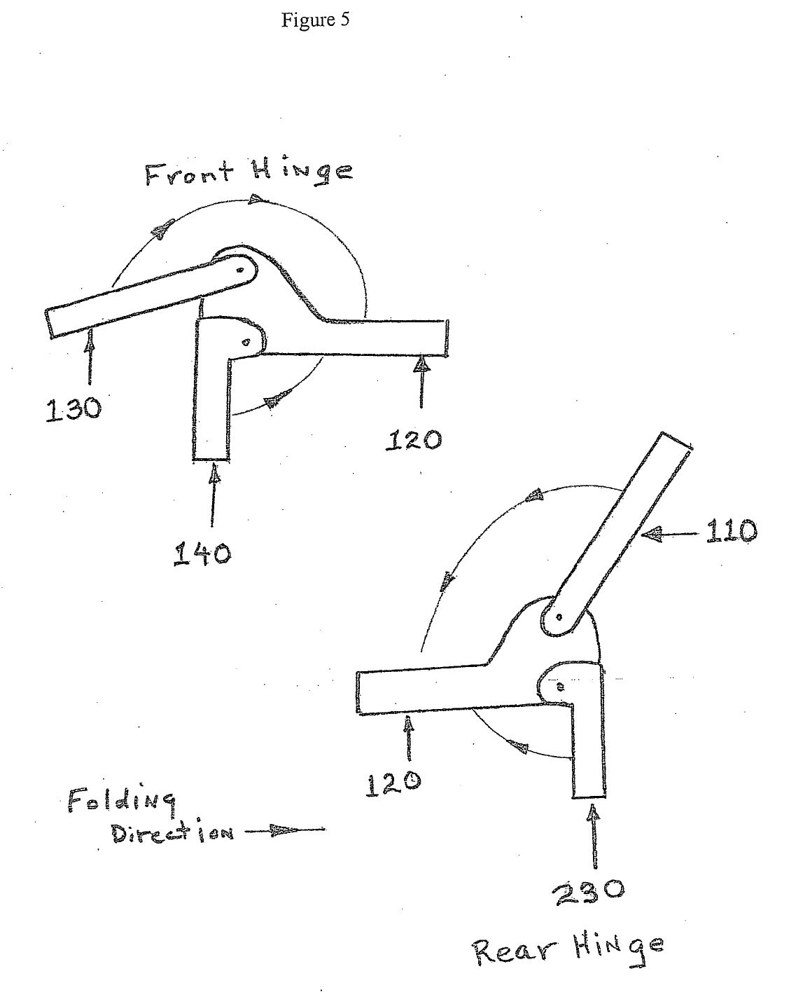

FIG. 5 shows how the hinges work on the front & back of the seat 120. The front hinge attaches to the ladder 140 and/or the leg rest 130 (Note the leg rest 130 is not always necessary because the ladder can also double as the leg rest by raising the ladder in to the leg rest position and inserting the locking pins, see FIG. 9.

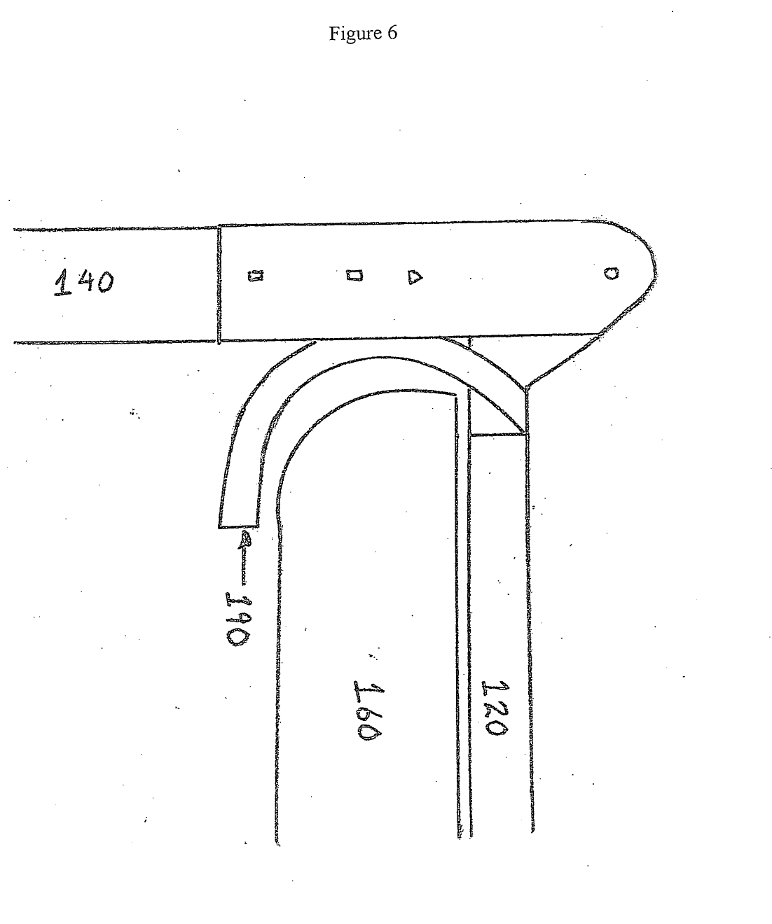

FIG. 6 is a side view of the front hinges hanging out over the tailgate with the ladder 140 in the unfolded position resting against attachment hooks 190, the attachment hooks 190 secure the OTG using a tie down 250 and the tightening lever 260.

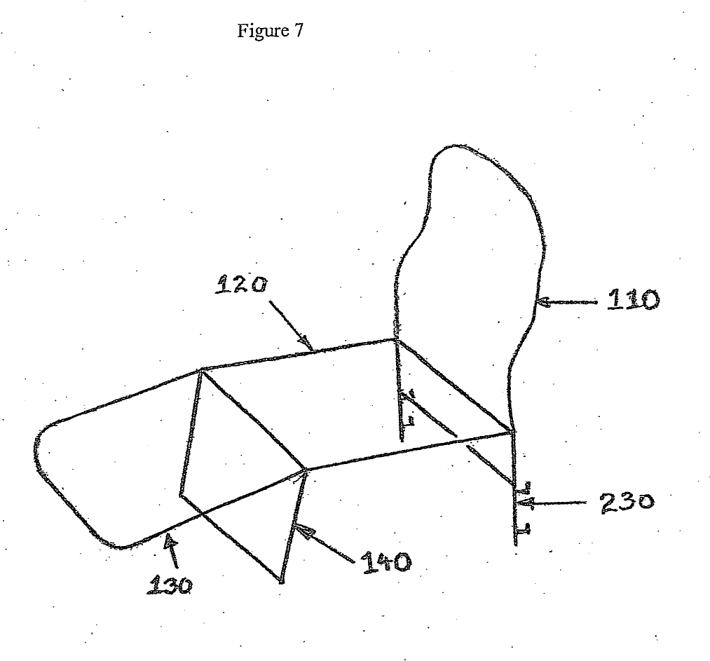

FIG. 7 shows the OTG in the ground position using the ladder 140 as the front leg and the back leg 230.

FIG. 8 shows the OTG sitting in place on the tailgate of a pick-up truck and how a nylon strap 240 can be used for both the ladder and chair positions.

FIG. 9 shows another possible way of connecting the OTG to the tailgate using the attachment hooks 190 and the tie down straps 250 attached to the tail gate hooking to the water vents on the bottom of all tailgates and then tightened with the lever 260 against the attachment hooks 190 securing the OTG to the tailgate, allowing the operator to open and close the tailgate with the OTG attached for easy access and use.

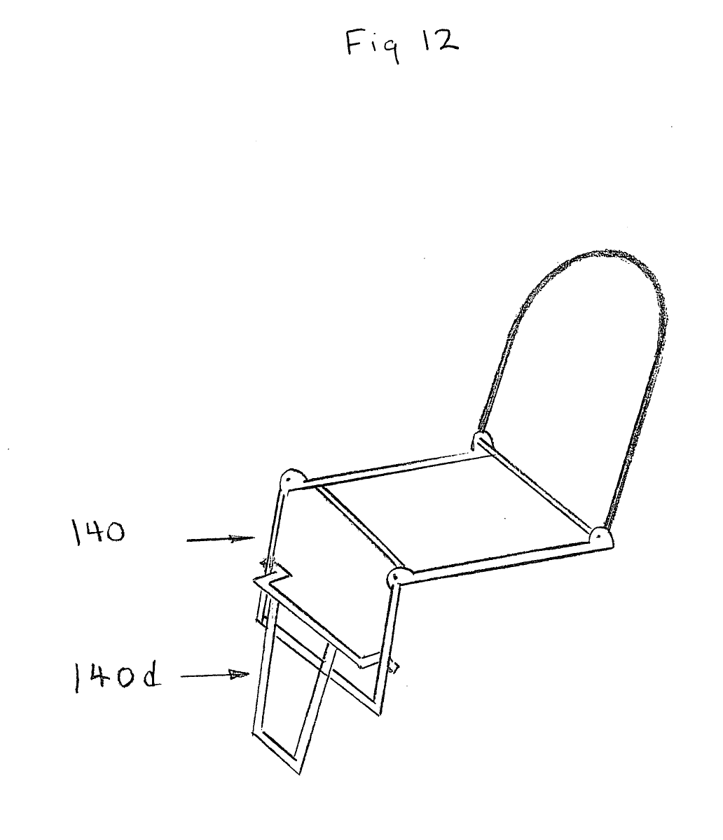

FIG. 10 shows where the Bicycle Rack attaches to the ladder 140A.

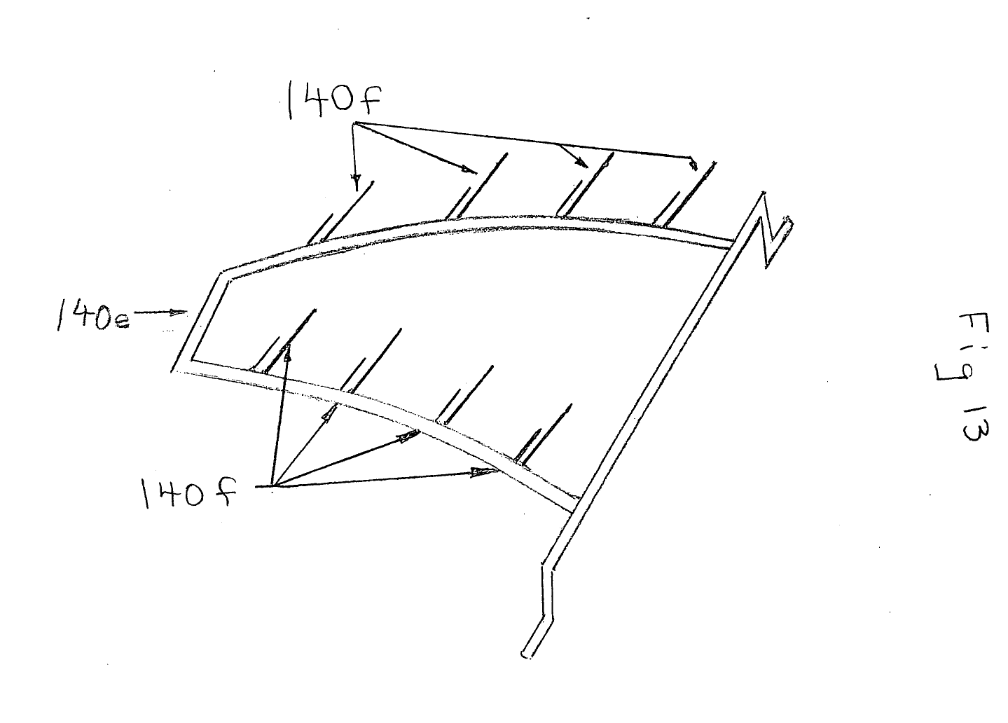

FIG. 11 shows the Bicycle Rack attaches to the ladder 140A.

FIG. 12 shows how the Bicycle Rack can also be used as a second step for the ladder.

FIG. 13 is similar to the Bicycle Rack, but metal slots which hold either 4 snowboards or sets of skis.

### INDEX

100 Awning
110 Backrest/handle for ladder
120 Seat/cushion
130 Leg rest
140 Ladder, leg rest, front legs of chair
140a Bicycle Rack attaches to the ladder
140b Bicycle Rack
140c Bicycle Attachment System
140d Secondary step for ladder
140e Snowboard/Ski Rack
140f Snowboard/Ski Rack attachment system
150 A folding step
150a Hinge for 150
160 Tailgate
190 Backrest stabilizer/hook for attachment
200 Safety strap
210 Backrest support/ladder handle support
220 Position hooks for 210
230 Back legs of chair and support arm for position hooks 220, which catch the backrest support 210
240 Another option for backrest/handle 210 support, a nylon leash or tether for 210
250 Tie down ratchet system
260 Lever for tightening the tie down straps 250

1-13. (canceled)

14. A foldable chair comprising:
a backrest;
a seat;
a ladder or bike rack; and
a connector configured to secure the system to a tailgate of a vehicle, wherein the backrest and ladder are configured to move between an extended position during use and a non-extended position when not in use.

15. The foldable chair of claim 14 wherein the backrest is attached to the seat through one or more hinges to allow movement between the extended and non-extended positions.

16. The foldable chair of claim 14 wherein the ladder is attached to the seat through one ore more hinges to allow movement between the extended and non-extended positions.

17. The foldable chair of claim 14, wherein the connector comprises one or more straps configured to extend around the tailgate of a vehicle to secure the foldable chair to the vehicle.

18. The foldable chair of claim 14, wherein the connector comprises one or more hooks configured to connect to the tailgate of the vehicle to secure the foldable chair to the vehicle.

19. The foldable chair of claim 18 further comprising four hooks, wherein two hooks are configure to attach to the front of the tailgate of a vehicle and two hooks are configured to attach to the back of the tailgate of a vehicle.

20. The foldable chair of claim 17, wherein the connector further comprises a tie down ratchet system to tighten the connector when deployed on the tailgate of a vehicle.

21. The foldable chair of claim 18, wherein the connector further comprises a tie down ratchet system to tighten the connector when deployed on the tailgate of a vehicle.

22. The foldable chair of claim 14 further comprising a rear leg assembly configured to move between an extended position and a non-extended position for use of the folding chair when not attached to the tailgate of a vehicle.

23. The foldable chair of claim 14, further comprising one or more of an armrest, a headrest, an awning, and a step.

24. A foldable chair comprising:
a backrest;
a seat;
a bicycle rack;
a ladder; and
a connector configured to secure the system to a tailgate of a vehicle, wherein the backrest and ladder are configured to move between an extended position during use and a non-extended position when not in use, wherein backrest is attached to the seat through one or more hinges to allow movement between the extended and non-extended positions, and wherein the ladder is attached to the seat through one or more hinges to allow movement between the extended and non-extended positions.

25. The foldable chair of claim 24, wherein the connector comprises one or more straps configured to extend around the tailgate of a vehicle to secure the foldable chair to the vehicle.

26. The foldable chair of claim 24, wherein the connector comprises one or more hooks configured to connect to the tailgate of the vehicle to secure the foldable chair to the vehicle.

27. The foldable chair of claim 25 further comprising four hooks, wherein two hooks are configure to attach to the front of the tailgate of a vehicle and two hooks are configured to attach to the back of the tailgate of a vehicle.

28. The foldable chair of claim 25, wherein the connector further comprises a tie down ratchet system to tighten the connector when deployed on the tailgate of a vehicle.

29. The foldable chair of claim 26, wherein the connector further comprises a tie down ratchet system to tighten the connector when deployed on the tailgate of a vehicle.

30. The foldable chair of claim 24, further comprising one or more of an armrest, a headrest, an awning, a bicycle rack, and a step.

31. A foldable chair comprising:
a backrest;
a seat;
a bicycle rack;
a ladder; and
a connector comprising two straps configured to extend around a tailgate of a vehicle to secure the foldable chair to the vehicle; wherein the backrest and ladder are configured to move between an extended position during use and a non-extended position when not in use, where in backrest is attached to the seat through one or more hinges to allow movement between the extended and non-extended positions, and wherein the ladder is attached to the seat through one or more hinges to allow movement between the extended and non-extended positions.

32. The foldable chair of claim 31, wherein the connector further comprises a tie down ratchet system to tighten the connector when deployed on the tailgate of a vehicle.

33. The foldable chair of claim 31, further comprising one or more of an armrest, a headrest, an awning, a step ladder, a bicycle rack, a snowboard rack with metal slots which hold either 4 snowboards or 4 sets of skis.
